(19) United States
(12) Patent Application Publication
(10) Pub. No.: US 2013/0132347 A1
(43) Pub. Date: May 23, 2013

(54) BACKUP METHOD FOR PORTABLE DEVICE

(71) Applicant: Johnny CHEN, Santa Ana, CA (US)

(72) Inventor: Johnny CHEN, Santa Ana, CA (US)

(73) Assignee: I O INTERCONNECT, LTD.

(21) Appl. No.: 13/302,788

(22) Filed: Nov. 22, 2011

(51) Int. Cl. G06F 17/30

(52) U.S. Cl. 707/648; 707/E17.007

(57) ABSTRACT

An embodiment of the invention provides a backup method for a portable device. The method comprises creating a first log file according to a first file that has to be stored in a backup device, connecting the portable device to the backup device. When the backup device is connected to the portable device, the backup device reads the first log file and stores the first file to the backup device.

### CROSS REFERENCE TO RELATED APPLICATIONS

This application claims the benefit of U.S. Provisional Application No. 61/435,631, filed on Jan. 24, 2011, the entirety of which is/are incorporated by reference herein.

### BACKGROUND OF THE INVENTION

1. Field of the Invention

The present invention relates to a backup method, and in particular relates to a backup method for a portable device.

2. Description of the Related Art

With the growth of the usage of the portable device, a problem has been raised, the backing up of data of the portable device. One solution is to connect the portable device to a computer or data storage device and store data therein. However, this solution may require some driver or specific software for the computer to retrieve and backs up data of the portable device and it is not convenient for a user. If the computer does not install the corresponding application program or driver, the computer cannot access the portable device even to back up data of the portable device.

### BRIEF SUMMARY OF THE INVENTION

An embodiment of the invention provides a backup method for a portable device. The method comprises creating a first log file according to a first file that is prepared to be stored in a backup device, connecting the portable device to the backup device. When the backup device is connected to the portable device, the backup device reads the first log file and stores the first file to the backup device.

Another embodiment of the invention provides a portable device comprising a log file, a first application and a first controller. The log file records information of a first file that is prepared to be backed up. The first application generates the log file. When the portable device connects to a backup device, the control of the portable device is transferred from the first controller to the backup device and the backup device stores the first file according to the log file.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a backup mechanism for a portable device according to an embodiment of the invention.

FIG. 2 is a flowchart of a backup method according to an embodiment of the invention.

FIG. 3 is a schematic diagram of a backup mechanism for a portable device according to another embodiment of the invention.

FIG. 4a shows a backup setting menu according to an embodiment of the invention.

FIG. 4b shows a customized backup setting menu according to an embodiment of the invention.

FIG. 4c shows a re-store setting menu according to an embodiment of the invention.

FIG. 5 is a schematic diagram of a backup mechanism for a portable device according to another embodiment of the present invention.

FIG. 6 is a flowchart of a backup and re-store method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

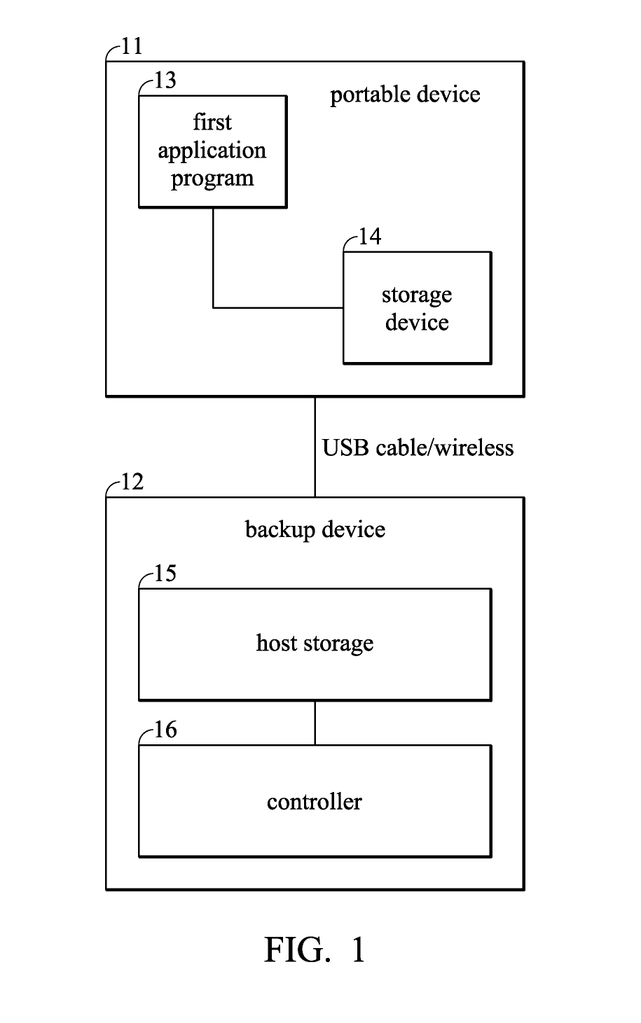

FIG. 1 is a schematic diagram of an embodiment of a backup mechanism for a portable device according to an embodiment of the present innovation. The portable device 11 comprises a first application program 13 and a storage device 14, such as an SD card, CF card or flash memory. The backup device 12 comprises a host storage 15 and a controller 16. When a user wants to backup files stored in the storage device 14, the user uses the first application program 13 to select and mark files to be backed up and the first application program 13 outputs a log file indicating which files have to be backed up. When the backup device 12 is electrically connected to the portable device 11, the backup device 12 reads the log file of the portable device 11 to know which files have to be backed up. The backup device 12 may directly read the log file stored in the storage device 14 and the log file would be reserved in the storage device 14. In another embodiment, the backup device 12 retrieves and stores the log file in the backup device, and the original log file stored in the will be deleted by the backup device 12. Then, the backup device 12 acquires and stores the files to be backed up in the host storage 15. When the backup device 12 is connected to the portable device 11, the control of the storage device 14 is transferred to the controller 16 of the backup device 12. After the backup device 12 finishes storing the file, the backup device 12 creates and stores a host log file in the storage device 14. The host log file records the file storage status. Finally, the backup device 12 is disconnected from the portable device 11, and the first application program 13 reads the host log file to know a backup result. The host log file may be temporality or permanently stored in the storage device 14. For example, the host log file may be deleted after the first application program 13 reads it for the security concern.

The present data backup procedure mainly comprises three parts. First, before the portable device 11 is connected to the backup device 12, the first application program 13 is executed to select and mark files to be backed up by a user. The first application program 13 then creates and stores a log file. The log file contains the information of the files to be backed up. The information may comprise file names of the file to be backed up.

Second, when the portable device 11 is connected to the backup device 12, the control of the storage device 14 is transferred to the backup device 12. In other word, the portable device 11 can operate as a peripheral device of the backup device 12. The backup device 12 reads the log file and stores the files to be backed up to the host storage 15. After storage, the backup device 12 creates and stores a host log file in the storage device 14, and breaks down the connection to the portable device 12.

Third, the first application program 13 is executed and reads the host log file to know the status of the backup.

In the present embodiment, the log file may not only record the information of the files to be backed up, but also a destination folder or path that indicates the destination folder.

In another embodiment, the log file contains a timestamp and the backup device 12 also stores the log file from the portable device 11. When the backup device 12 accesses the log file from the portable device 11, the backup device 12 also reads a previous log file stored in the backup device 12, and the backup device 12 only stores the unstored files according to the log file and the previous log file. The backup device 12 comprises a first log file database storing the log files from the portable device 12, and the portable device 11 comprises a second log file data storing the host log files created by the backup device 12. Each time the portable device 11 backs up the data or files to the backup device 12, the first application program 13 or the backup device 12 can find a previous host log file or a previous log file to determine which files are new for backup. The described backup mechanism also can be applied to the restore function.

The host log file also contains a timestamp, and when the first application program 13 creates the log file, the first application program 13 will check a previous host log file to see whether the current selected files have been stored in the backup device 12. If yes, the current log file will exclude the stored files from the current log file. It is noted that, if the destination folder of the destination path of the previously stored files is different from the current destination folder of the destination path, the stored files will be stored in the current destination folder of the destination path.

The described paragraphs are focused on the backup mechanism for the portable device 11. Another embodiment of the restored mechanism for the portable device 11 is discussed in the following. When a user wants to restore some files from the backup device 12 to the portable device 11, the first application program 13 creates a first log file indicating which files have to be restored to the portable device 11. When the backup device 12 is connected to the portable device 11, the controller 16 reads the first log file and restores the requested files to the portable device 11. After restoration, the backup device 12 also creates and stores a first host log file to the storage device 14.

Via the first application program 13, a user can set data between two dates to be restored from the backup device 12 to the portable device 11. For example, if a user wants to restore the pictures taken from Jan. 1, 2011 to Jan. 10, 2011, the user can input some parameters, such as date and data type information, via the first application program 13 and then the first application program searches matched files stored in the portable device and creates the log file according to the user's inputs. Furthermore, the user can set which type of files to be backed up via the first application program. Similarly, this can also be applied to the restore mechanism. In this embodiment, the type of the file means the file format, such as JPG, JPEG, RAM file format, audio file format, video file format or other formats.

In the present embodiment, the backup device 12 may also comprise a second application program for backing up the data of the portable device 11 or restoring the data from the backup device 12 to the portable device. The backup device 12 may also comprise a dock for connecting a connector of the portable device 11. Wireless connection mechanisms, security mechanisms or synchronization mechanisms may also be applied to the portable device 11 and backup device 12.

In the previous description, the embodiment is illustrated with wired or physical connection between the portable device 11 and the backup device. However, the invention is not limited thereto. The described backup mechanism can also be applied in the situation that the portable device wirelessly connects the backup device. The backup device 12 can communicate with the portable device 11 via wireless interface, such as Wifi, WiMax, Bluetooth, IrDa, NFC (Near Field Communication) or other wireless interfaces. When a distance between the portable device 11 and the backup device 12 is shorter than a predetermined distance, the backup device 12 automatically wirelessly connects to the portable device and the portable device 11 transfers the control of the storage device 14 to the backup device 12. Although the portable device 11 is connected to the backup device 12 actually, the backup device 12 only sees the storage device 14 in the aspect view of the backup device 12. Simply speaking, the backup device 12 is virtually connected to the storage device 14 but actually connected to the portable device. After the virtual connection between the storage device 14 and the backup device 12 is established, the control of the storage device 14 is transferred to the backup device 12. It means that the user of the portable device 11 cannot see the storage device 14. When the backup device 12 accesses the storage device 14, the command, request, or data to the storage device 14 is still transferred by a processor or a control unit of the portable device 11. The backup device 12 then reads the log file stored in the storage device 14 and backs up the files in the backup device 12. After backing up, the backup device breaks down the wireless connection to the portable device 11 and the control of the storage device 14 is returned to the portable device 11. Furthermore, when the storage device 14 is virtually connected to the backup device 12, a synchronization application program can be executed to directly synchronize and back up the data of the portable device 11 and via the wireless connection, the backup device 12 can simultaneously connects to more than one portable device or other computing device to back up the data therein when the wireless connection has been established.

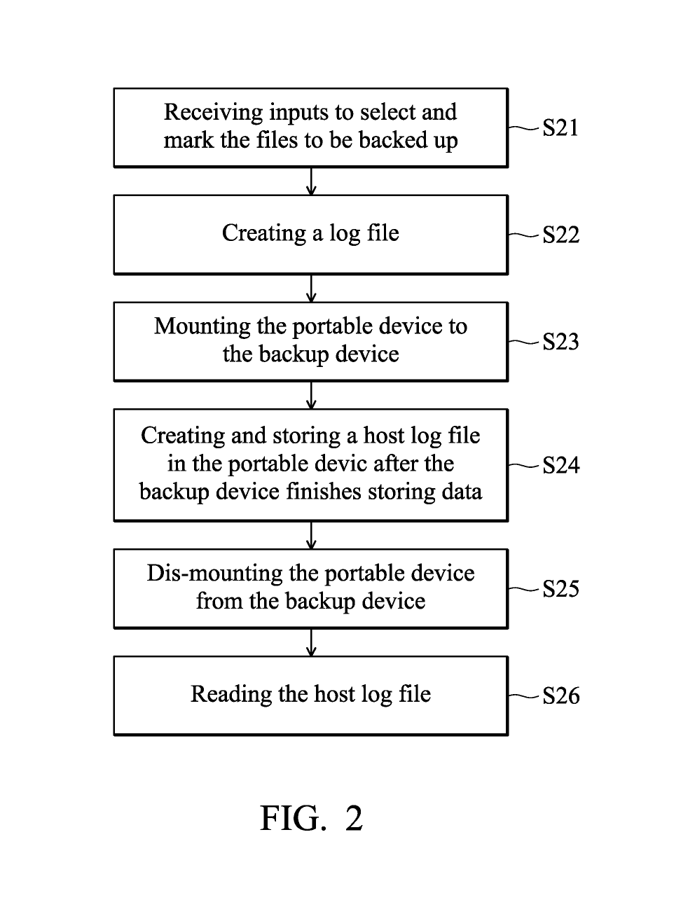

FIG. 2 is a flowchart of a backup method according to an embodiment of the present embodiment. In step S21, the portable device receives inputs to select and mark the files to be backed up. A user can input parameters via a touch panel or keypad of the portable device to select files to be backed up. Furthermore, voice control may also be applied. In step S22, a first application program of the portable device creates a log file according to user inputs. In step S23, the backup device mounts the portable device, and the control of the storage device 14 is then transferred to the backup device. The backup device reads the log file and stores the files from the portable device to the backup device according to the log file. In step S24, when the backup device finishes storing data, the backup device creates and stores a host log file in the portable device. In step S25, the backup device dis-mounts the portable device. In step S26, the portable device reads the host log file to check the status of the backed up file.

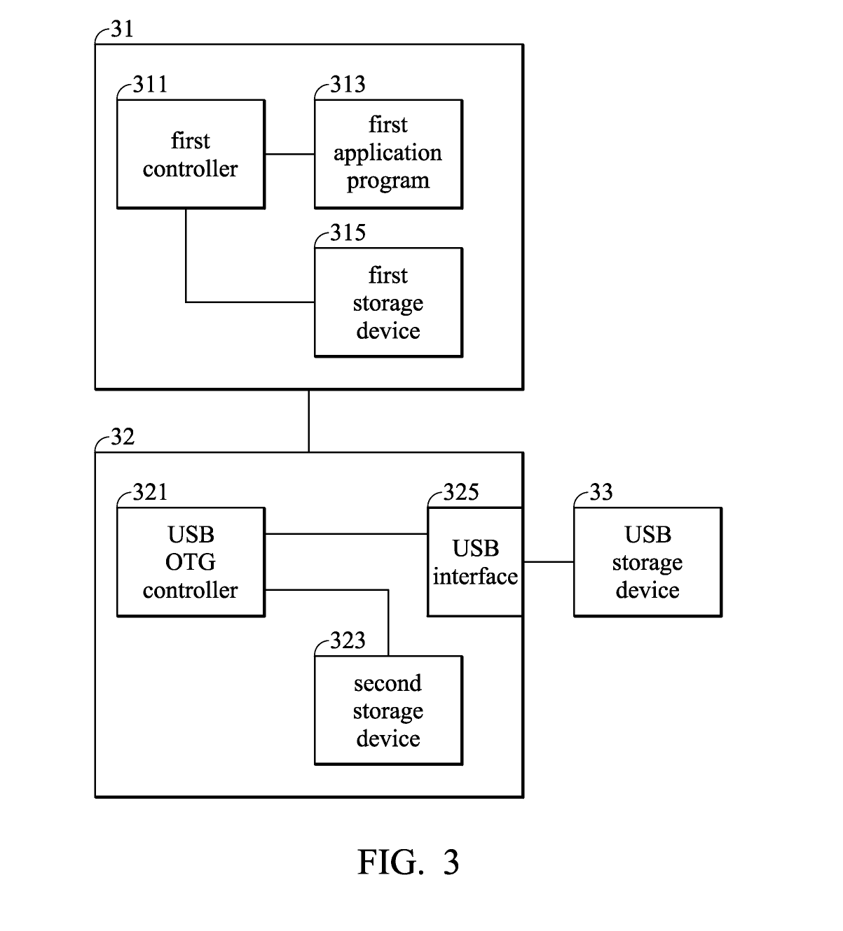

FIG. 3 is a schematic diagram of a backup mechanism for a portable device according to another embodiment of the invention. The portable device 31 comprises a first controller 311, a first application program 313 and a first storage device 315. The dock 32 comprises a USB OTG (On To Go) controller 321, a second storage device 323 and a USB connector for connecting a USB storage device 33. The portable device 31 has a connector for connecting the dock 32. In another embodiment, the dock 32 has a first slot with a male connector and the portable device 31 has a female connector for connecting the male connector. In another embodiment, the portable device 31 connects to the dock 32 via a connection cable. The first storage device 315 may be a SD card or other kinds of memory cards. The first storage device 312 is inserted and mounted to the portable device 31 by user and stores user's personal data. The portable device 31 may comprises another storage device storing the necessary data for the operation of the portable device 31, such as the operating system, application programs or hardware configuration data.

When the portable device 31 connects to the dock 32, the control of the first storage device is transferred to the USB OTG controller 321. In other words, the first storage device 315 can only be accessed by the USB OTG controller 321 and cannot be accessed by the first controller 311. The first application program 313 is executed by the first controller 311 and user can select at least one file to be backed up to the dock 32 via the first application program 313. After selecting files, the first application program 313 creates a first log files. The first application program 313 may show a setting menu for user to select files to be backed up.

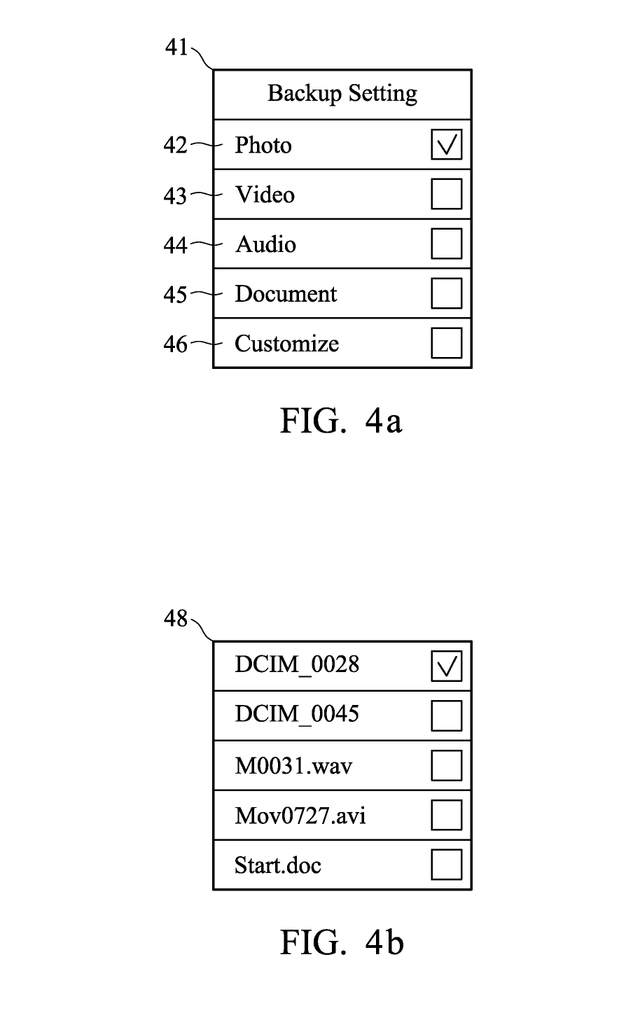

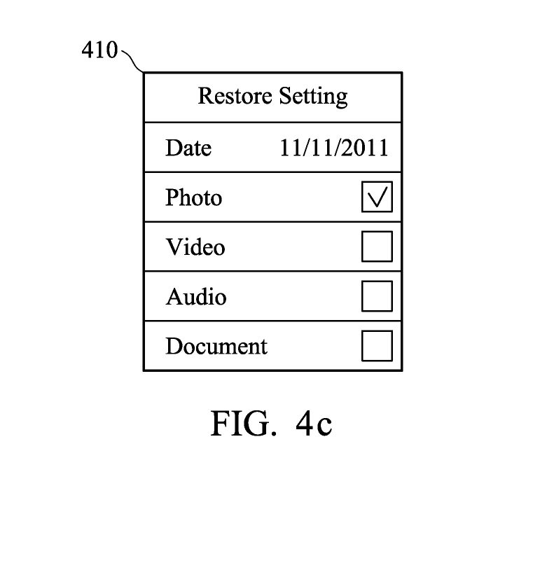

Please refer to FIG. 4a. FIG. 4a shows a backup setting menu according to an embodiment of the invention. The backup setting menu 41 comprises option fields 42 to 46. When the option field 42 is selected, all the photo file or image file of the portable device 31 would be backed up to the dock 32. When the option field 43 is selected, all the video files of the portable device 31 would be backed up to the dock 32. When the option field 44 is selected, all the audio files of the portable device 31 would be backed up to the dock 32. When the option field 45 is selected, all the document files of the portable device 31 would be backed up to the dock 32. When the option field 46 is selected, another option menu 48 pops out. The option menu 48 contains file names of all files of the portable device 31 and the user can select files to be backed up via the option menu 48. After selecting, the first application program 313 creates a log file for the dock 32 to back up files. The backup setting menu further comprises an option field (not shown in FIG. 4a) to back up the contact list of the portable device. The contact list does not limit to the phone contact list, and the contact list related to a social network service can also be backed up to the backup device.

In another embodiment, the backup setting menu 41 comprises a destination folder setting option and a synchronization option. The user can set a specific folder for storing the backup data from the portable device 31 via the destination folder setting option and creates another folder for synchronizing a designated folder of the portable device 31. If the user has set synchronization option, the dock 32 will automatically synchronize the portable device 31 and store the modified, changed or newly added file in the designated folder when the portable device 31 connects to the dock 32.

It is noted that the first application program 313 can be executed at anytime base on the need of the user. The user can first executes the first application program 313 to create the first log file and then connects the portable device 31 to the dock 32. In another example, the user can directly connect the portable device 31 to the dock 32 and after the first controller 311 detects that the portable device 31 has been connected to the dock 32, the first application program 313 is then automatically executed.

The first log file contains the information of the files to be backed up. The information may comprise file names of the files to be backed up. The log file may not only record the information of the files to be backed up, but also a destination folder or path indicating the destination folder that the files to be backed up. In another embodiment, the log file contains a timestamp and the USB OTG controller 321 backs up data of the portable device 31 only according to the file creation date. For example, the dock 32 has backed up the data of the portable device 31 on Jan. 1, 2011, and when the user connects the portable device 31 to the dock 32 on Jan. 11, 2011, the dock 32 only backs up the data generated, changed or modified between Jan. 1, 2011 and Jan. 11, 2011 in the portable device 31. In other words, an incremental backup mechanism is applied in the dock 32.

The incremental backup preserves data by not creating multiple copies that are based on the differences in those data: a successive copy of the data contains only that portion which has changed since the preceding copy has been created. The most basic form of incremental backup involves only those files that have changed since the last backup. Since changes are typically low, incremental backups are much smaller and quicker than full backups.

After the portable device 31 connects to the dock 32, the USB OTG controller 321 reads the first log file stored in the first storage device 315 and then backs up files from the first storage device 315 to the second storage device 323 or the USB storage device 33. The USB OTG controller 321 can store the backup data in different folders according to different data sources. For example, the dock 32 creates a first folder to store the backup data from a first portable device and creates a second folder to store the backup data from a second portable device. When the portable device 31 connects to the dock 32, the USB OTG controller 32 first identifies the portable device 31 to select or create a corresponding folder to store the backup data. The dock 32 comprises a USB connector 325 for connecting the USB storage device 33. The dock 32 can store the backup data to the second storage device 323 or the USB storage device 33 according to first log file. In another embodiment, when the second storage device 323 is full or does not exist, the dock 32 stores the backup data to the USB storage device 33.

After the dock 32 stores the backup data, the USB OTG controller 321 creates and stores a second log file to the first storage device 315. Then, the USB OTC controller 321 transfers the control of the first storage device 315 back to the first controller 311. This means the first storage device 315 can be accessed by only the first controller 311. The first controller 311 reads the second log file to know the backup status, such as backup fail, backup success or the backup date.

In this embodiment, the dock 32 can restore the backup data to the portable device 31. The user first executes the first application 313 to select a restore date or the files to be restored, and then creates a third log file. For example, if a user wants to restore the pictures taken from Jan. 1, 2011 to Jan. 10, 2011, the user sets some parameters, such as the date and the data format information, via the first application program 43 to create the third log file. When the portable device connects to the dock 32, the USB OTG controller 321 reads the third log file and stores the selected files to the first storage device 315. In another embodiment, the user can restore files with a specific format. For example, when the user wants to restore the pictures from the dock 32 to the portable device 31, the user can create a restore log file via the first application program 313. The first application program 313 can show a setting menu, such as shown in FIG. 4c, for user. The user first sets a restore date and then selects the data type of the restored data.

Although the described paragraphs illustrates the backup or restore mechanism with four data types, the user still can select specific format to be backed up or restored via the first application program 313. For example, the formats of photo comprise JPG format, JPEG format, BMP format and other formats, and the user can select only the photo with JPG format to be backed up or restored. All the setting of backup and restore will be transformed to data that can be read by the USB OTG controller 321 and stored in the log file.

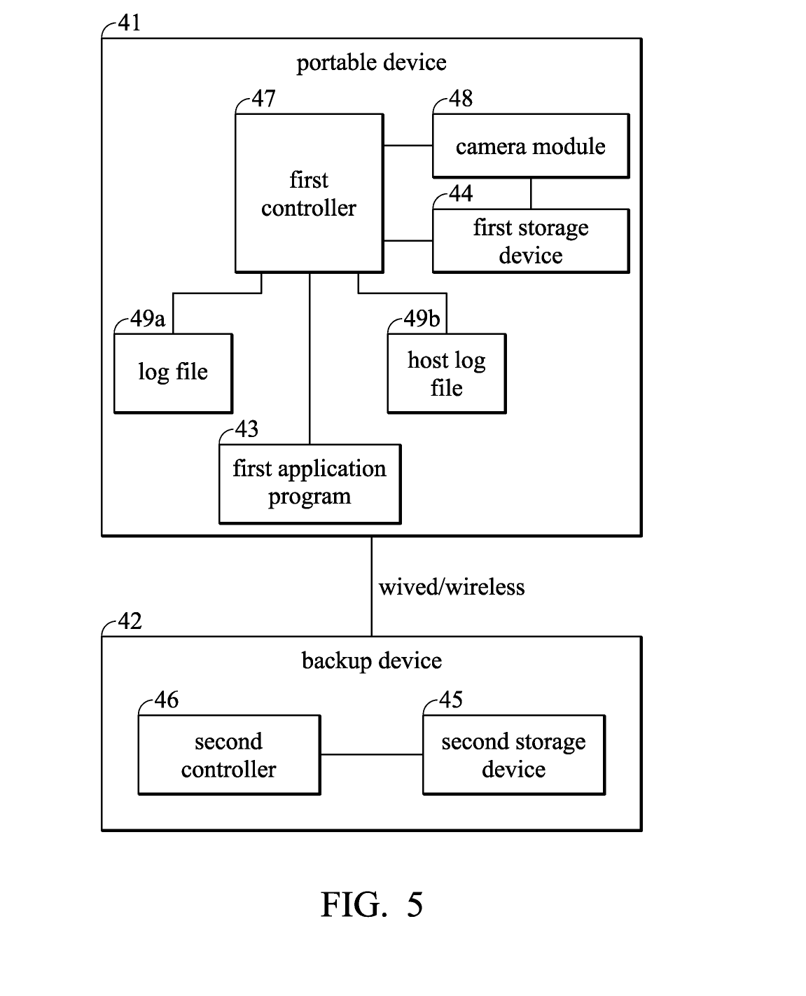

FIG. 5 is a schematic diagram of a backup mechanism for a portable device according to another embodiment of the present invention. The portable device 41 comprises a first controller 47, a camera module 48, a first application program 43 and a first storage device 44, such as an SD card, CF card or flash memory. In another embodiment, the first storage device 44 is external and

The backup device 42 comprises a second storage device 45 and a controller 46. When a user wants to backup and store files to the second storage device 45, the user first uses the first application program 43 to select first files that have to be backed up and then the first application program 43 creates a log file 49a according to the first files. The log file 49a comprises the file names of the first files, formats of first files and a timestamp recording the backup date of the first files.

The following paragraphs are focused on the backup mechanism for the portable device 41 that has the same operating system as the backup device. When the backup device 42 is electrically connected to the portable device 41, the control of the storage device 14 is first transferred to the second controller 46, and then the second controller 46 reads the log file 49a of the portable device 41 to know which files have to be backed up. The backup device 32 acquires and stores the first files to the second storage device 45 according to the log file 49a. After the first files are stored in the second storage device 45, the second controller creates and stores a host log file 49b in the portable device 41. The host log file 49a records the status of the backup procedure of the first files. Finally, the backup device 42 is disconnected from the portable device 41, and the first controller 47 reads the host log file to know the backup status.

In FIG. 5, the portable device 41 comprises a camera module 48 for taking photos. The photos taken by the camera module 48 also contain a timestamp. Therefore, the backup device 42 can automatically back up the photos according to the timestamp. For example, when the portable device 41 connects to the backup device 42 for a first time, a second application program (not shown in FIG. 5) automatically stores all the photos and pictures of the portable device 41. Then, the second application program finds and records a latest date from the timestamps of the corresponding photos and pictures. When the portable device 41 connects to the backup device 42 again, the second application program finds photos or pictures that are not stored in the backup device 42 according to the latest date, and then stored the unstored photos or pictures in the second storage device 45.

A restored mechanism for the portable device 41 is also discussed in the following. When a user wants to restore second files from the backup device 42 to the portable device 41, the first application program 43 first creates a first log file containing the information of the second files that have to be restored to the portable device 41. When the backup device 42 is connected to the portable device 41, the second controller 46 reads the log file and restores the second files to the portable device 41. After restoration, the backup device 42 also creates and stores a host log file to the portable device 41.

Via the first application program 47, a user can only select data between two dates to be restored from the backup device 42 to the portable device 41. For example, if a user wants to restore the pictures taken from Jan. 1, 2011 to Jan. 10, 2011, the user can input some parameters, such as the date and the data format information, via the first application program 43 and then the first application program 43 creates the log file according to the user's choices. Furthermore, a user can select to backup files with some specific format to be backed up device 42 via the first application program 43.

In the present embodiment, the backup device 42 may also comprises the second application program for backing up the data of the portable device 41 or restoring the data from the backup device 42 to the portable device 41. The backup device 42 may also comprises a dock for connecting a connector of the portable device. Wireless connection mechanisms, security mechanisms or synchronization mechanisms may also be applied to the portable device 41 and backup device 42.

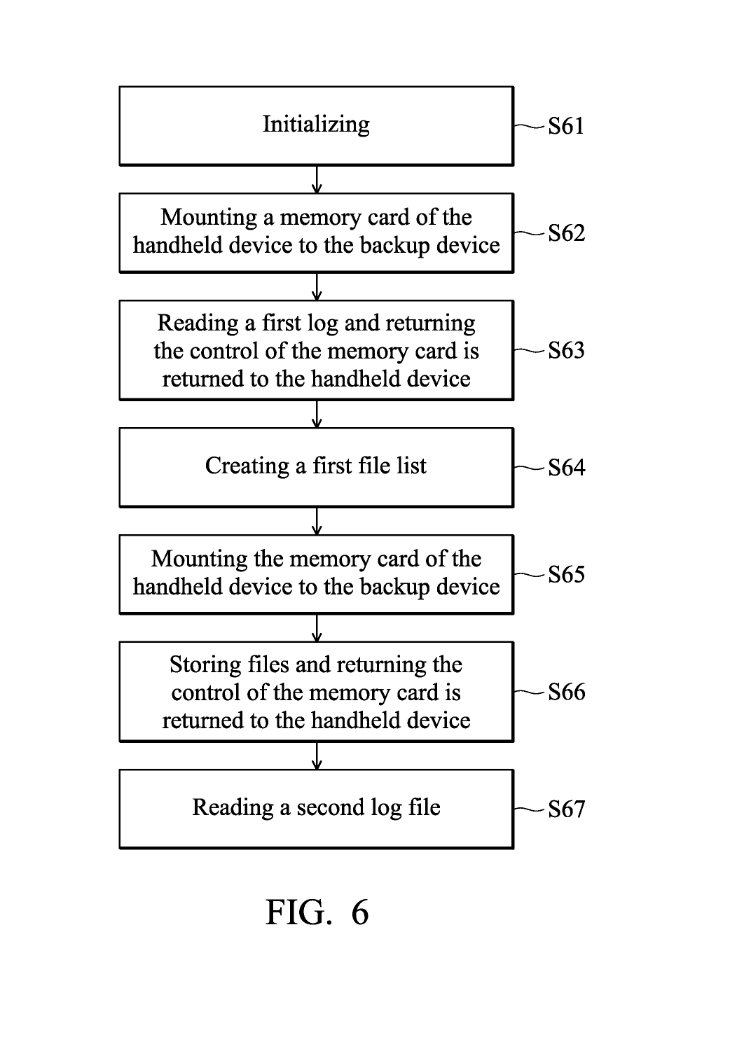

FIG. 6 is a flowchart of a backup and re-store method according to another embodiment of the invention. In step S61, an application program or a backup device is initialized. The backup device connects to a handheld device to back up data from the handheld device to the backup device or re-store data from the backup device to the handheld device. The initialization comprises a step of scanning the handheld device and the backup device to find storage type devices comprising both internal and external storage medium. Before or during the initialization, user can select which data to be backed up or determines a recovery date to restore data via an input menu or interface. Then, the handheld device creates and stores a first log file in a memory card or an external storage device of the handheld device. In the step S62, the memory card of the handheld device is mounted to the backup device. It means that the control of the memory card is transferred from the handheld device to the backup device. In other words, the user of the handheld device cannot access the memory card via the handheld device.

In the step S63, the backup device reads the first log file, wherein the first log file contains the information of the files to be backed up or restored. In another embodiment, the backup device duplicates the first log file and stored the duplicated first log file to a storage device of the backup device. After that, the control of the memory card is returned to the handheld device. In step S64, the backup device compares the current files with the files to be backed up or restored to create a first file list showing only the files to be deleted or created. In the step S65, the memory card the handheld device is mounted to the backup device again. In the step S66, the backup device stores files or deletes files according to the file list. After that, the backup device returns the control of the memory card to the handheld device. In step S67, the handheld device reads a second log file generated in the step S66 to know the backup or re-store status.

The first log file or the second log file comprises at least three parts: status list, command list and file list. The status list indicates result of the backup operation or the re-store operation. The command list is generated only by the handheld device to inform the backup device which operation is adopted. The file list is the key feature of the log file. The file list comprises file names of files to be backed up or deleted, directory of the files and a directory structure of the memory card. When generating the first log file, a backup program of the handheld device may directly records the current directory structure of the memory card or only the directory structure of the files related to the backup operation or re-store operation. The backup device then compares the directory structure of the first log file with a current directory of the backup device to generate the first file list. In another embodiment, the backup device compares the first log file with a previous log file that the handheld device generated to generate the firs log file.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backup method for a portable device, comprising:
creating a first log file according to a first file that has to be stored in a backup device; and
connecting the portable device to the backup device,
wherein when the backup device is connected to the portable device, the backup device reads the first log file and stores the first file to the backup device.

2. The method as claimed in claim 1, wherein when the portable device connects to the backup device, the control of the storage device is transferred to the backup device.

3. The method as claimed in claim 1, further comprising:
when the backup device finishes storing the first file, the backup device generates and stores a second log file in the portable.

4. The method as claimed in claim 3, further comprising:
reading the second log file by the portable device to acquire backup status information of the first file.

5. The method as claimed in claim 1, wherein the first log file comprises a file name of the first file and a timestamp.

6. The method as claimed in claim 1, further comprising:
when the backup device finishes storing the first file, the control of the portable device is returned to the portable device from the backup device.

7. The method as claimed in claim 1, further comprising:
selecting a file format;
generating a third log file according to the file format, wherein the third log file recording a third file with the file format of the portable device; and
storing the third file to the backup device when the portable device connects to the backup device.

8. The method as claimed in claim 1, further comprising:
generating a fourth log file according to a fourth file that is stored in the backup device; and
storing the fourth file to the portable device by the backup device after the backup device reads the fourth log file.

9. The method as claimed in claim 1, further comprising:
generating a fourth log file according to a first date and a second date;
storing a fourth file to the portable device by the backup device after the backup device reads the fourth log file, wherein a backup date of the fourth file is between the first date and the second date.

10. A portable device, comprising:
a log file recording information of a first file that has to be backed up;
a first application to generate the log file; and
a first controller, wherein when the portable device connects to a backup device, the control of the portable device is transferred from the first controller to the backup device and the backup device stores the first file according to the log file.

11. The device as claimed in claim 10, wherein after the backup device finishes storing the first file, the backup device generates and stores a second log file in the portable device, and then the control of the portable device is transferred back to the first controller, and the first controller reads the second log file to know a backup status of the first file.

12. The device as claimed in claim 10, wherein the first log file comprises a file name of the first file and a timestamp.

13. The device as claimed in claim 10, further comprising a third log file that is generated according to a third file stored in the backup device, and when the portable device connects to a backup device, the backup device stores the third file to the portable device according to the third log file.

14. The device as claimed in claim 10, wherein the log file further records a third file to be backed up in the backup device, and when the backup device reads the log file and determines that the third file has already been stored in the backup device, the backup device only stores the first file to the backup device.

15. A dock for storing data of a portable device, comprising:
a first storage device; and
a controller to detect whether the portable device connects to the dock, read a first log file stored in a second storage device of the portable device, store at least file from the second storage device to the first storage device according to the first log file and create and store a second log file in the second storage device after the file is stored in the first storage device, wherein when the portable device connects to the dock, the control of the second storage device is transferred from the portable device to the controller.

16. The dock as claimed in claim 15 further comprising a connector to connect an external storage device, and the controller stored a file from the portable device to the external storage device according to the first log file.

17. The dock as claimed in claim 15, wherein the second log file stores a backup status of the stored file.

18. A data processing method for a portable device, comprising:
creating a first log file according to first files; and
connecting the portable device to the backup device,
transferring the control of a storage device from the portable device to a backup device;
reading the first log file and returning the control of the storage device from the backup device to the portable device;
generating a first file list related to the first files according to the first log file;
transferring the control of the storage device from the portable device to the backup device after the generation of the first file list;
storing the first files and generating a second log file indicating a backup status of the first files.

19. The method as claimed in claim 18, further comprising:
creating a restore log file according to a restore date;
creating a second file list according to the restore log file; and
storing second files to the portable device from the backup device according to the second file list.
